(19) United States
(12) Patent Application Publication
(10) Pub. No.: US 2026/0220182 A1
(43) Pub. Date: Jul. 30, 2026

(54) RESPONSE CACHING FOR MACHINE LEARNING SYSTEMS

(71) Applicant: Salesforce, Inc., San Francisco, CA (US)

(72) Inventors: Luis Campo Giralte, Madrid (ES); Alvaro Alcedo Moreno, Madrid (ES)

(21) Appl. No.: 19/039,994

(22) Filed: Jan. 29, 2025

(51) Int. Cl. G06F 16/34; G06F 16/22; G06F 16/2455; G06F 40/30

(52) U.S. Cl. CPC G06F 16/345; G06F 16/2237; G06F 16/24552; G06F 40/30

(57) ABSTRACT

Systems, devices, and techniques are disclosed for response caching for machine learning systems. A vector including data and time values may be received. A point of interest, including data over a range of time values, in the vector may be determined. A request including the vector, the range of time values, and a request question may be sent to a machine learning system. A text response may be received from the machine learning system. The text response, a vector identifier that identifies the vector, and an index indicating the range of time values may be stored in a cache as a cached response. A user request including an indication of data of interest and an indication of a time period of interest may be received from a user. The text response stored in the cache may be determined to be responsive to the user request.

### BACKGROUND

Merchants can use data collected for their online stores to determine actions they can take to maintain and improve their online stores and increase performance. Merchants may need to spend large amounts of time analyzing data to determine which actions to take and then actually performing these actions. A merchant may perform the determined actions, such as creating promotions for low-performing products, manually, and may only be able to do so on an intermittent, for example, weekly, basis. This can result in actions being taken by the merchant being less timely and less effective at leveraging the collected data to increase the performance of the online store.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for response caching for machine learning systems according to an implementation of the disclosed subject matter.

FIG. 2 shows an example arrangement suitable for response caching for machine learning systems according to an implementation of the disclosed subject matter.

FIG. 3 shows an example arrangement suitable for response caching for machine learning systems according to an implementation of the disclosed subject matter.

FIG. 4 shows an example arrangement suitable for response caching for machine learning systems according to an implementation of the disclosed subject matter.

FIG. 5 shows an example procedure suitable for response caching for machine learning systems according to an implementation of the disclosed subject matter.

FIG. 6 shows an example procedure suitable for response caching for machine learning systems according to an implementation of the disclosed subject matter.

FIG. 7 shows a computer according to an implementation of the disclosed subject matter.

FIG. 8 shows a network configuration according to an implementation of the disclosed subject matter.

### DETAILED DESCRIPTION

Techniques disclosed herein enable response caching for machine learning systems, which may allow for responses generated by machine learning systems to be cached allowing for the responses to be reused and resulting in increased efficiency in responding to questions input to machine learning systems. A vector including data and time values may be received. A point of interest that includes data over a range of time values in the vector may be determined. A request may be sent to a machine learning system including the vector, the range of time values, and a request question that requests that the machine learning system analyze the data of the vector based on the range of time values. A text response may be received from the machine learning system. The text response, a vector identifier that identifies the vector, and an index including the range of time values may be stored in a cache. A user request including indications of data of interest and a time period of interest may be received from a user. The text response stored in the cache may be determined to be responsive to the user request based on the indications of data of interest and the time period of interest. A request including the text response from the cache may be sent to a secondary language processor. A summarization of the text response may be received from the secondary language processor. The summarization of the text response may be sent to the user.

A vector including data and time values may be received. The data included in the vector may be any data that may be part of a time series of data. The data included in the vector may be, for example, price data for an asset, such as securities or currencies, sales data for a single product, product category, or online store, or website traffic data. Items of data included in the vector may be timestamped either directly, for example, with the vector storing each item of data with the time for that data, or indirectly, for example, with the item of data's location in the vector indicating the time for that data. The vector may be received from any suitable source, such as, for example, a database of a cloud computing server system, at a response caching system that may be implemented on any suitable system or computing device.

A point of interest that includes data over a range of time values in the vector may be determined. A point of interest in the vector may be, for example, a maxima or minima, or an abrupt rise or drop. The point of interest may be determined by the response caching system that received the vector using any suitable form of data analysis. Before a point of interest in the vector is determined, the vector may be subjected to smoothing. For example, the vector may include data for the real-time stock price for shares of a Company A between the hours of 10:00 am and 11:00 am. The stock price may show an abrupt rise between 10:15 am and 10:17 am. The data in the vector between 10:15 am and 10:17 am may be determined to be a point of interest for the vector. The range of time values for the point of interest may be in the form of an index, or indexes, into the vector that points to the data that was determined to be the point of interest.

A request may be sent to a machine learning system including the vector, the range of time values, and a request question that requests that that the machine learning system analyze the data of the vector based on the range of time values. The request sent to the machine learning system may be generated in any suitable manner by any suitable computing device or system and may be generated without user input. The request may include the vector and the determined point of interest, including the range of time of values. The question may be a generically phrased question written in plain language that may be suitable for input to a machine learning system, such as a generative pre-trained transformer (GPT) that may ask whether there is anything interesting about the data of the vector around the determined point of interest. For example, the question may be “Based on the vector {vector data} and a point of interest from {point of interest−10 to point of interest+10}, can something be inferred?”, where {vector data} may be the vector from which the point of interest was determined and point of interest−10 to point of interest+10} may be a range from the vector that starts 10 items of data before the front of the range of time values of the point of interest and ends 10 items of data after the end of the range of time values of the point of interest. This may result in the machine learning system analyzing data from the vector over a range that includes the determined point of interest and data both before and after the determined point of interest. The request may be sent to the machine learning system in any suitable manner, including, for example, through an API call to the machine learning system.

A text response may be received from the machine learning system. The machine learning system may analyze the data in the vector based on the question in the request and generate a text response. The text response may be received by the response caching system that sent the request, and may be received as, for example, an API response. The response may be any suitable response that may be generated by a machine learning system such as a GPT in response to the request. For example, the response may be:
The graph illustrates a noticeable 25% increase in the data over a specific period, indicating a significant upward spike. This surge could represent growth in various domains, such as sales, user engagement, or market trends, depending on the context of the analysis. The sharp increase is an important highlight, suggesting a pivotal change in behavior or external factors influencing the metrics
While the initial spike is prominent, the data following this increase shows a slower growth pattern. The upward trend continues, but at a more gradual pace compared to the rapid 25% jump. This could imply that the initial spike was driven by a specific event or a temporary factor, after which the growth stabilized. A possible explanation for the more moderate incline could be market saturation, customer retention strategies, or the natural progression of demand after a period of high excitement.

Overall, the graph shows a trend of consistent but slow growth after the 25% spike. This indicates that while the surge was impactful, the long-term trajectory is steady rather than exponential. Businesses or analysts monitoring this graph may focus on sustaining the growth and identifying the cause of the spike to capitalize on similar opportunities in the future. Understanding the underlying factors can help in developing strategies to either recreate such spikes or maintain consistent growth over time.

The text response, a vector identifier that identifies the vector, and an index including the range of time values may be stored in a cache. The cache may be part of any suitable database using any physical storage that may be connected to or otherwise accessible to the response caching system that received the text response from the machine learning system. The text response may be stored in the cache along with a vector identifier that uniquely identifies the vector from which the point of interest was determined and the range of time values for the point of interest, which may be an the form of an index or indexes into the vector. The text response, vector identifier, and range of time values may be stored in the cache for any suitable length of time and may be removed for any suitable reason, such as, for example, to allow for the regeneration of text responses with new data.

The response caching system that received the vector, determined the point of interest, sent the request to the machine learning system, and received and stored the text response may operate in a batch mode. In batch mode, the response caching system may continually receive vectors of data from any suitable sources, may determine any number of points of interest in the vectors, including multiple points of interest in the same vector, send requests to the machine learning system for the determined points of interest, and store the text responses received from the machine learning system along with vector identifiers and ranges of times values in the cache. This may result in the cache storing any number of text responses for points of interest across any number of vectors.

A user request including indications of data of interest and a time period of interest may be received from a user. The request from the user may be, for example, a plain language text input that may be intended for a machine learning system, such as GPT, including, for example, the machine learning system used to generate the text responses. The request from the user may request enrichment data, for example, insights or inferences, about a set of data from a point or period in time, specified in any suitable manner. For example, the request from the user may be “What happened to Company A's stock price this morning?” The request may be received by the response caching system.

The text response stored in the cache may be determined to be responsive to the user request based on the indications of data of interest and the time period of interest. The response caching system may analyze the request from the user in any suitable manner, including, for example, using natural language processing (NLP), to determine the data that is the subject of the request. For example, the response caching system may determine that data for Company A's stock price between 9:30 am and 12:00 pm may be the subject of the user's request regarding Company A's stock price. The response caching system may then determine if a text response has already been generated and stored in the cache for a point of interest at the specified time, or in the specified time range, of the request from the vector that stores the data that is the subject of the request. The response caching system may, for example, determine the appropriate vector identifier for the vector that includes the data is the subject of the user's request and may then determine if any text response in the cache was stored along with that vector identifier. From among the text responses stored in the cache along with that vector identifier, the response caching system may determine which was stored with a range of time values that is similar to the time period of interest of the user request and retrieve that text response. For example, the response caching system, in response to a user's request regarding Company A's stock price that morning, may determine that the text response stored in the cache with the vector identifier for the vector that stores Company A's stock price and with a range of time values that covers that morning may be responsive to the user's request and may retrieve that text response from the cache.

A request including the text response from the cache may be sent to a secondary language processor. The response caching system may send the text response retrieved from the cache in response to the user's request to a secondary language processor. The secondary language processor may be implemented on any suitable system or computing device, may use NLP techniques for text summarization, information retrieval, and extraction of key sentences to represent the main points of an input text, may be less computationally expensive than the machine learning system used to generate the text responses. The secondary language processor may, for example, use LexRank. The request may be sent using an API call, or in any other suitable manner.

A summarization of the text response may be received from the secondary language processor. The secondary language processor may generate a summary of the text response received from the response caching system and may send the summarization to the response caching system. The summarization of a text response may be much shorter than the text response. For example, a summarization of a text response may be “There is a 25% increase and the tendency is and growing slowly.” The summarization of a text response may be received as, for example, an API response.

The summarization of the text response may be sent to the user. The response caching system may return the summarization of the text response to the user as a response to the user's request. This may allow the user's request to be responded to based on the previously generated and stored text response from the cache instead of by sending the user's request to the machine learning system. As many users may attempt to send similar requests to the machine learning system, having cached text responses that are responsive to those requests may reduce the number of duplicate requests that the machine learning system must respond to, reducing the amount of computational resources used by the machine learning system and allowing the machine learning system to be more responsive to requests that cannot be responded to using a text response from the cache.

When the response caching system receives a request from a user that cannot be responded to using a text response from the cache, the response caching system may send the user's request to the machine learning system. The response caching system may identify an appropriate vector that includes that data that is the subject of the user's request and may send this vector to the machine learning system, or the machine learning system may identify the appropriate vector. The machine learning system may then generate a text response that is responsive to the user's request. The text response may be sent to the response caching system, which may store in the cache the text response, along with vector identifier for the vector that included the data used by the machine learning system to generate the text response and range of time values, as an index or indexes into the vector, of that data. This may allow the text response to be retrieved based on future user's requests that are duplicative of the user request that the text response was generated to be responsive to. The response caching system may send the text response to the secondary language processor, receive the summarization, and return the summarization to the user as a response to the user's request.

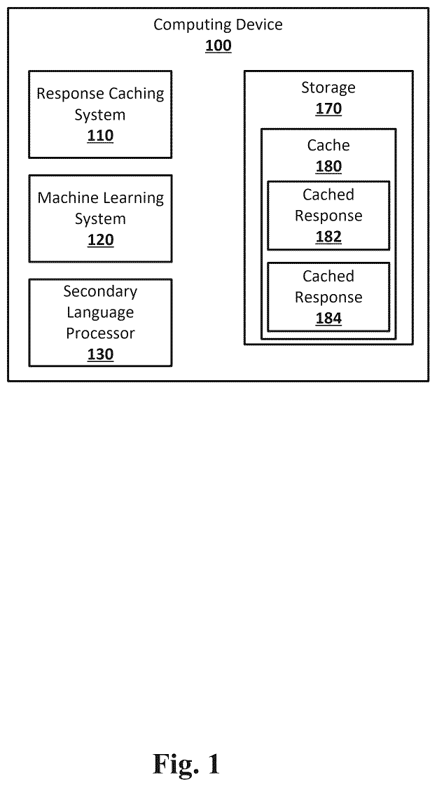

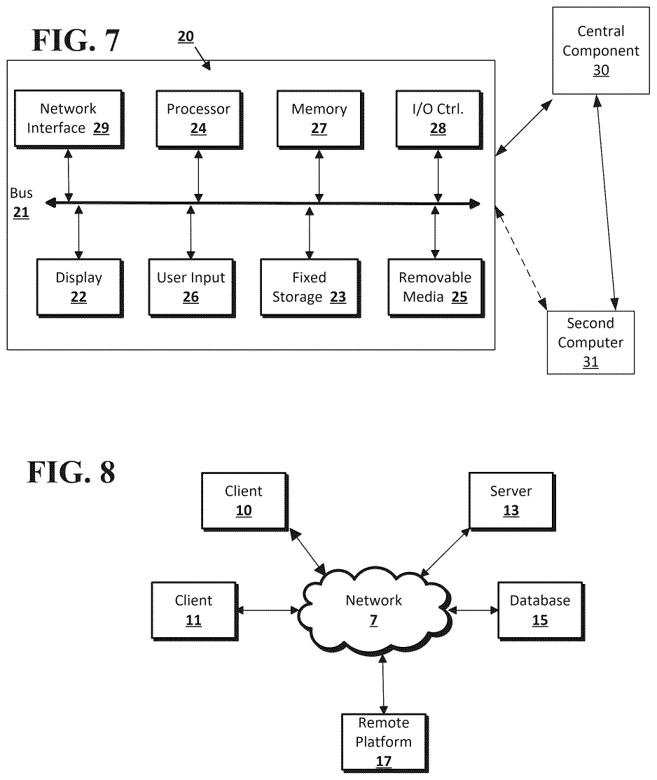

FIG. 1 shows an example system suitable for response caching for machine learning systems according to an implementation of the disclosed subject matter. A computing device 100 may be any suitable computing device, such as, for example, a computer 20 as described in FIG. 7, or component thereof, for implementing response caching for machine learning systems. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs). For example, the computing device 100 may be, or be part of, a cloud computing sever system that may be a multi-tenanted server system.

The computing device 100 may include a response caching system 110. The response caching system 110 may be any suitable combination of hardware and software of the computing device 100 for implementing a response caching system that may manage the caching of responses generated by a machine learning system. The response caching system 110 may, for example, receive vectors that include data and time value, determine points of interest in the vectors, send API calls to a machine learning system to have text responses analyzing the points of interest generated, cache the text responses along with identifiers for the vectors and points of interest, determine when user requests can be answered using cached text responses, send cached text responses to a secondary language processor, and return summarization of text responses from the secondary language processor to users. The response caching system 110 may operate in a batch mode in which the response caching system continually receives vectors, determines points of interest in the vectors, uses the machine learning system to generate text responses analyzing the points of interest, and caches the text responses. The response caching system 110 may also operate in an inline mode in which the response caching system 110 receives and responds to user request either using cached responses or by sending the user request to the machine learning system to generate a text response that may then be sent back to the user and cached for future use. The response caching system 110 may operate in both batch mode and inline mode at the same time, or may, for example, operate in batch mode at times when there is less demand on the machine learning system from other sources.

The computing device 100 may include a machine learning system 120. The machine learning system 120 may be any suitable combination of hardware and software of the computing device 100 for implementing a machine learning system that may generate text responses when given a vector and range of time values in the vector as input. The machine learning system 120 may be implemented using any suitable structure for a machine learning system, and may, for example, by a GPT-based system. The machine learning system 120 may receive API calls from the response caching system 110 that include a vector, an indication of a range of time values, and a request to analyze the data in the vector within and around the range of time values and may generate a text response that includes the requested analysis. The machine learning system 120 may be implemented on the computing device 100, which may be, for example, a server system, or may be implemented on any suitable system or computing device that may be in communication with the computing device 100 and the response caching system 110.

The computing device 100 may include a secondary language processor 130. The secondary language processor 130 may be any suitable combination of hardware and software of the computing device 100 for generating summarizations of text responses. The secondary language processor 130 may, for example, use NLP techniques for text summarization, information retrieval, and extraction of key sentences to represent the main points of an input text, may be less computationally expensive than the machine learning system 120. The secondary language processor 130 may, for example, use LexRank. The secondary language processor 130 may receive text responses from the response caching system 110, for example, through an API call, and send summarization of the text responses to the response caching system 110.

The storage 170 may be any suitable combination of hardware and software for storing data. The storage 170 may include any suitable combination of volatile and non-volatile storage hardware and may include components of the computing device 100 and hardware accessible to the computing device 100, for example, through wired and wireless direct or network connections. The storage 170 may store a cache 180. The cache 180 may store cached responses, such as cached responses 182 and 184, generated by the response caching system 110. A cached response may include a text response generated by the machine learning system 120 along with an identifier of the vector that was used as input to the machine learning system 120 and an index including the range of time values for the point of interest that was analyzed by the machine learning system 120.

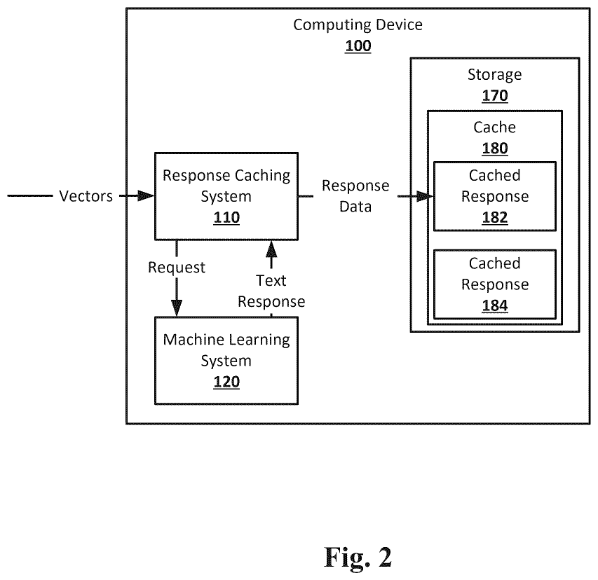

FIG. 2 shows an example arrangement suitable for response caching for machine learning systems according to an implementation of the disclosed subject matter. When operating in batch mode, the response caching system 110 may receive vectors with data and time values. The vectors may be received from any suitable sources, including, for example, databases external to the computing device 100. The vectors may include any suitable data. For example, vectors may include data for the prices of stocks, securities, and currencies, over any suitable time period. Vectors may include recent data, for example, with data for time values that end only at the time the vector is sent to the response caching system 110, such that the data in the vector may as close to current as possible at the time the vector is received at the response caching system 110.

The response caching system 110 may determine a point of interest that includes data over a range of time values in a received vector. A point of interest in the vector may be, for example, a maxima or minima, or an abrupt rise or drop. The response caching system 110 may determine the point of interest using any suitable form of data analysis. Before a point of interest in the vector is determined, the vector may be subjected to smoothing. For example, the vector may include data for the real-time stock price for shares of a Company A between the hours of 10:00 am and 11:00 am. The stock price may show an abrupt rise between 10:15 am and 10:17 am. The data in the vector between 10:15 am and 10:17 am may be determined to be a point of interest for the vector. The range of time values for the point of interest may be in the form of an index, or indexes, into the vector that points to the data that was determined to be the point of interest.

The response caching system 110 may generate a request to be sent to the machine learning system 120. The request may include a received vector, the range of time values for the point of interest in the received vector, and a request question that requests that that the machine learning system 120 analyze the data of the vector based on the range of time values. The request sent to the machine learning system 120 may be generated in any suitable manner. The request question may be a generically phrased question written in plain language that may be suitable for input to the machine learning system 120 that may ask whether there is anything interesting about the data of the vector around the determined point of interest. For example, the question may be “Based on the vector {vector data} and a point of interest from {point of interest−10 to point of interest+10}, can something be inferred?”, where {vector data} may be the vector from which the point of interest was determined and point of interest−10 to point of interest+10} may be a range from the vector that starts 10 items of data before the front of the range of time values of the point of interest and ends 10 items of data after the end of the range of time values of the point of interest. This may result in the machine learning system 120 analyzing data from the vector over a range that includes the determined point of interest and data both before and after the determined point of interest. The response caching system 110 may send the request to the machine learning system 120 in any suitable manner, including, for example, through an API call to the machine learning system 120.

The response caching system 110 may receive a text response from the machine learning system 120. The machine learning system 120 may analyze the data in the vector based on the question in the request and generate a text response. The text response may be received by the response caching system 110 as, for example, an API response.

The response caching system 110 may store response data, including the text response received from the machine learning system 120, a vector identifier that identifies the vector, and an index including the range of time values for the point of interest from the vector may be stored in the cache 180 as the cached response 182. The cached response 182 may include the text response along with a vector identifier that uniquely identifies the vector from which the point of interest was determined and the range of time values for the point of interest, which may be an the form of an index or indexes into the vector. The cached response 182 including the text response, vector identifier, and range of time values may be stored in the cache 180 for any suitable length of time and may be removed for any suitable reason, such as, for example, to allow for the regeneration of text responses with new data. The response caching system 110 may store cached responses in the cache 180 for any suitable number of the vectors received by the response caching system 110. Multiple cached responses may be stored for the same vector if the vector includes multiple points of interest that may be sent to the machine learning system 120 in separate requests and have separate text responses generated.

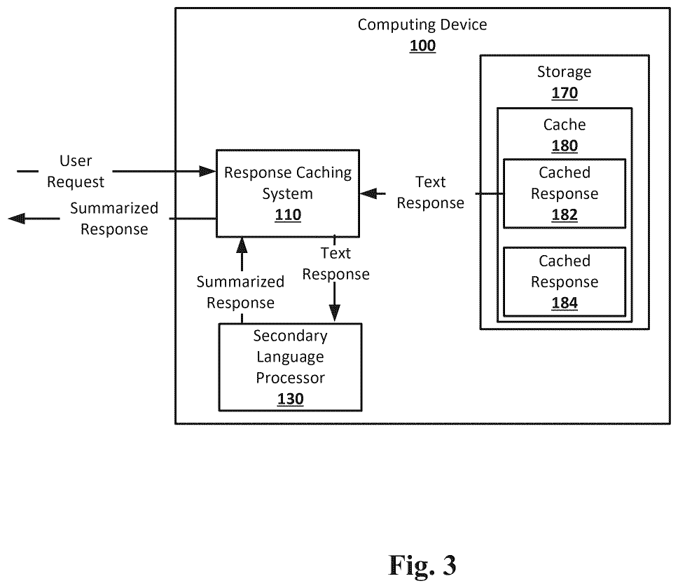

FIG. 3 shows an example arrangement suitable for response caching for machine learning systems according to an implementation of the disclosed subject matter. The response caching system 110 may receive a user request including indications of data of interest and a time period of interest. The user request may be, for example, a plain language text input that may be intended for the machine learning system 120. Requests from users intended for the machine learning system 120 may be directed to the response caching system 110 first. The user request may request enrichment data, for example, insights or inferences, about a set of data from a point or period in time, specified in any suitable manner. For example, the request from the user may be “What happened to Company A's stock price this morning?”

The response caching system 110 may determine that the text response 182 stored in the cache 180 may be responsive to the user request based on the indications of data of interest and the time period of interest in the user request. The response caching system 110 may analyze the request from the user in any suitable manner, including, for example, using natural language processing (NLP), to determine the data that is the subject of the request. For example, the response caching system 110 may determine that data for Company A's stock price between 9:30 am and 12:00 pm may be the subject of the user's request regarding Company A's stock price. The response caching system 110 may then determine if a text response has already been generated and stored in the cache 180 for a point of interest at the specified time, or in the specified time range, of the request from the vector that stores the data that is the subject of the request. The response caching system 110 may, for example, determine the appropriate vector identifier for the vector that includes the data is the subject of the user's request and may then determine if any text response in the cache 180 was stored along with that vector identifier. From among the text responses stored in the cache 180 along with that vector identifier, the response caching system 110 may determine which was stored with a range of time values that is similar to the time period of interest of the user request and retrieve that text response. For example, the response caching system 110, in response to a user's request regarding Company A's stock price that morning, may determine that the cached response 182 stored in the cache 180 with the vector identifier for the vector that stores Company A's stock price and with a range of time values that covers that morning may be responsive to the user's request and may retrieve that text response from the cached response 182.

The response caching system 110 may send a request including the text response from the cached response 182 to the secondary language processor 130. The response caching system 110 may send the text response from the cached response 182 retrieved from the cache 180 in response to the user's request to a secondary language processor 130. The secondary language processor 130 may generate a summarized response that may be a summary of the text response received from the response caching system 110. The summarized response may be much shorter than the text response. For example, the summarized response may be “There is a 25% increase and the tendency is and growing slowly.”

The response caching system 110 may receive the summarized response, which may be a summary of the text response, from the secondary language processor 130. The summarized response may be received by the response caching system 110 as, for example, an API response from the secondary language processor 130.

The response caching system 110 may send summarized response to the user. The response caching system 110 may return the summarized response to the user as a response to the user's request. This may allow the user's request to be responded to based on the previously generated and stored text response from the cached response 182 in the cache 180 instead of by sending the user's request to the machine learning system 120. As many users may attempt to send similar requests to the machine learning system 120, having cached text responses that are responsive to those requests may reduce the number of duplicate requests that the machine learning system 120 must respond to, reducing the amount of computational resources used by the machine learning system 120 and allowing the machine learning system 120 to be more responsive to requests that cannot be responded to using a text response from the cache 180.

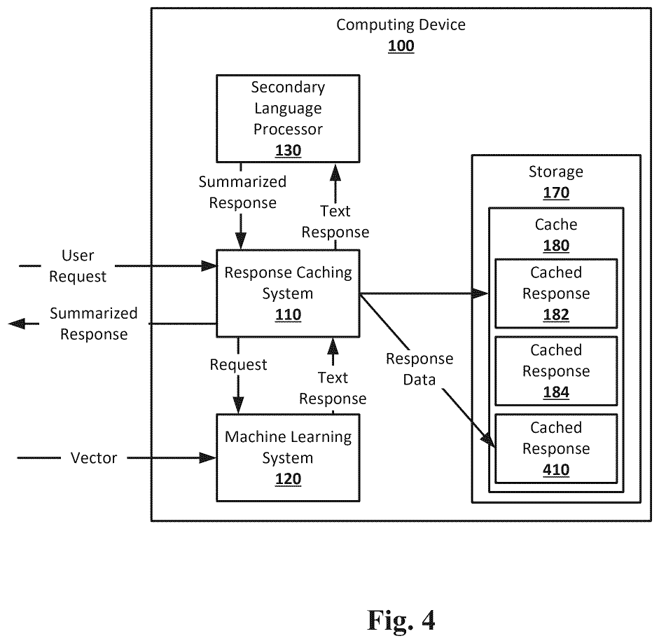

FIG. 4 shows an example arrangement suitable for response caching for machine learning systems according to an implementation of the disclosed subject matter. The response caching system 110 may receive a request from a user that cannot be responded to using a text response from a cached response in the cache 180. The response caching system 110 may receive the user request and may determine that no cached response in the cache 180 includes a vector identifier that identifies the vector that includes the data that is the subject of the user request or that no cached response that does include the vector identifier that identifies the vector that includes the data that is the subject of the user request also includes a range of time values that includes the data that is the subject of the user request. This may indicate that no cached response has been generated from the data that is the subject of the user request and thus no cached response includes a text response that is responsive to the user request.

The response caching system 110 may send the user's request to the machine learning system 120. The response caching system 110 may identify an appropriate vector that includes that data that is the subject of the user's request and may send this vector to the machine learning system 120 with the user's request, or the machine learning system 120 may identify the appropriate vector. The machine learning system 120 may then generate a text response that is responsive to the user's request. The text response may be sent to the response caching system 110, which may store in the cache 180, as the cached response 410, the text response, along with vector identifier for the vector that included the data used by the machine learning system 120 to generate the text response and range of time values, as an index or indexes into the vector, of that data. This may allow the text response to be retrieved based on future user's requests that are duplicative of the user request that the text response was generated to be responsive to. The response caching system 110 may send the text response to the secondary language processor 120, receive the summarized response, and return the summarized response to the user as a response to the user's request.

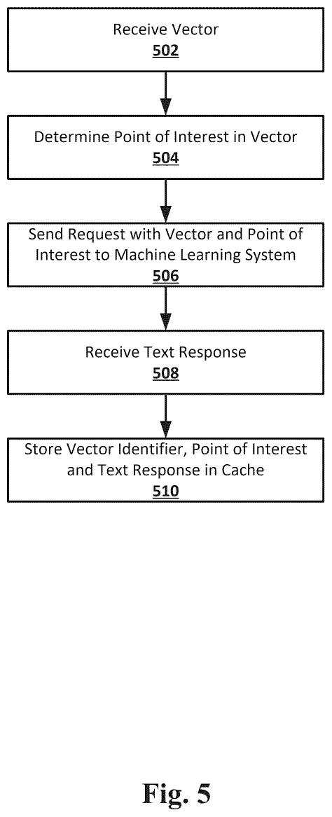

FIG. 5 shows an example procedure suitable for response caching for machine learning systems according to an implementation of the disclosed subject matter. At 502, a vector may be received. For example, the response caching system 110 may receive a vector from any suitable source of data. The vector may include any suitable data with time values.

At 504, a point of interest in the vector may be determined. For example, the response caching system 110 may determine a point of interest in the received vector using any suitable form of data analysis. A point of interest in the vector may be, for example, a maxima or minima, or an abrupt rise or drop. Before a point of interest in the vector is determined, the vector may be subjected to smoothing. The range of time values for the point of interest may be in the form of an index, or indexes, into the vector that points to the data that was determined to be the point of interest.

At 506, a request with the vector and the point of interest may be sent to a machine learning system. For example, the response caching system 110 may send the vector, the time values of the point of interest, and a question asking for an analysis of the vector at the point of interest, to the machine learning system 120. The request may be sent as, for example, an API call to the machine learning system 120.

At 508, a text response may be received. For example, the response caching system 110 may receive a text response generated by the machine learning system 120 based on the request from the response caching system 110. The text response may be received by the response caching system 110 as, for example, an API response.

At 510, a vector identifier, the point of interest, and the text response may be stored in a cache. For example, the response caching system 110 may store response data, including a vector identifier for the vector, an indication of the point of interest in the vector, and the text response generated by the machine learning system 120 based on the vector and the point of interest, as the cached response 182 in the cache 180. This may allow the text response to be retrieved from the cached response 182 at a later time.

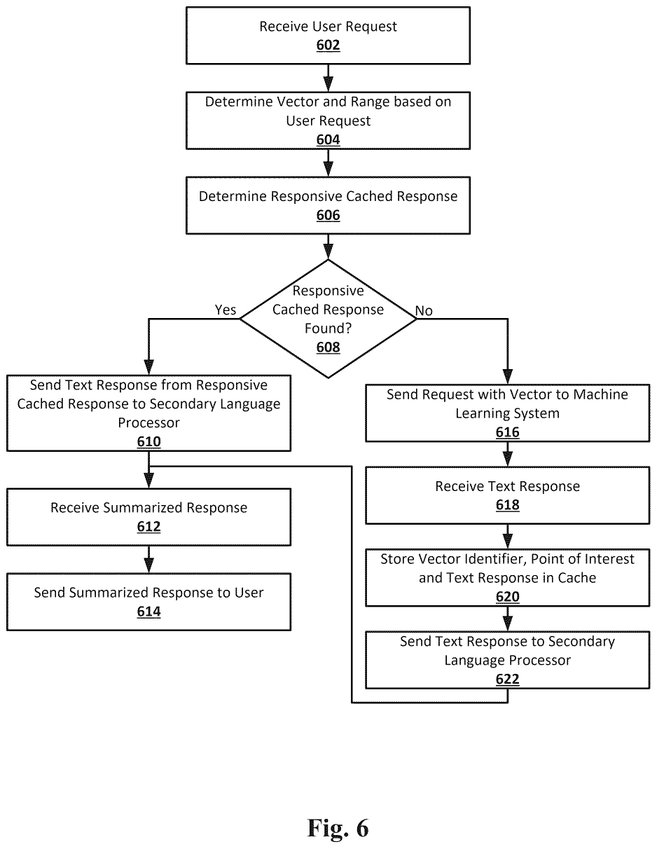

FIG. 6 shows an example procedure suitable for response caching for machine learning systems according to an implementation of the disclosed subject matter. At 602, a user request may be received. For example, the response caching system 110 may receive a request from a user through, for example, an API call. The user request may be a plain language text input that may be intended for the machine learning system 120. Requests from users intended for the machine learning system 120 may be directed to the response caching system 110 first. The user request may request enrichment data, for example, insights or inferences, about a set of data from a point or period in time, specified in any suitable manner.

At 604, a vector and range may be determined based on the user request. For example, the response caching system 110 may analyze the user request in any suitable manner, including, for example, using natural language processing (NLP), to determine the data that is the subject of the request, including determining the vector and range of time values within that vector that store the data the is the subject of the user request. This may be the data that would be used by the machine learning system 120 to generate a response to the user request if the user request were sent directly to the machine learning system 120 instead of to the response caching system 110.

At 606, a response cached response may be determined. For example, the response caching system 110 may determine if a text response has already been generated and stored in the cache 180 for a point of interest at the specified time, or in the specified time range, of the user request from the vector that stores the data that is the subject of the request. The response caching system 110 may, for example, determine the appropriate vector identifier for the vector that includes the data is the subject of the user's request and may then determine if any text response in the cache 180 was stored in a cached response along with that vector identifier. From among the cached responses that include text responses stored in the cache 180 along with that vector identifier, the response caching system 110 may determine which was stored with a range of time values that is similar to the time period of interest of the user request and retrieve that text response.

At 608, if a responsive cached response is found, flow may proceed to 610. For example, the response caching system 110 may determine that the cached response 182 in the cache 180 includes the vector identifier for the vector that includes data that is the subject of the user request and a range of time values that includes the data the is the subject of the user request. This may indicate that the cached response 182 is responsive to the user request. Otherwise, flow may proceed to 616 if none of the cached responses in the cache 180 are determined to be responsive to the user request. For example, the response caching system 110 may determine that no cached response includes both the vector identifier for the vector that includes data that is the subject of the user request and a range of time values that includes the data the is the subject of the user request. This may indicate that no cached response is responsive to the user request, as the data that is the subject of the user request may not have been analyzed yet by the machine learning system 120.

At 610, a text response from the responsive cached response may be sent to a secondary language processor. For example, the response caching system 110 may have determined that the cached response 182 is responsive to the user request. The response caching system 110 may send the text response from the cached response 182 to the secondary language processor 130 along with an instruction to summarize the text response. The text response may be sent through, for example, an API call to the secondary language processor 130.

At 612, a summarized response may be received. For example, the response caching system 110 may receive a summarized response from the secondary language processor 130. The summarized response may be a summary of the text response sent by the response caching system 110 to the secondary language processor 130.

At 614, the summarized response may be sent to the user. For example, the response caching system 110 may send the summarized response to the user that submitted the user request to the response caching system 110. The summarized response may be a response to the user request, and may be sent as, for example, an API response.

At 616, a request with the vector may be sent to a machine learning system. For example, the response caching system 110 may not have found a cached response in the cache 180 that was responsive to the user request. The response caching system may send to the machine learning system 120, for example, as an API call, the vector that includes the data that is the subject of the user request along with the user request itself. In some implementations, the response caching system 110 may only send the user request to the machine learning system 120 which may itself retrieve the appropriate vector to generate a response to the user request.

At 618, a text response may be received. For example, the response caching system 110 may receive a text response generated by the machine learning system 120 based on the user request, vector, and range of time values from the response caching system 110. The text response may be received by the response caching system 110 as, for example, an API response.

At 620, a vector identifier, point of interest, and the text response may be stored in a cache. For example, the response caching system 110 may store response data, including a vector identifier for the vector that includes the data that is the subject of the user request, an indication of a point of interest in the vector based on the user request, and the text response generated by the machine learning system 120 based on the vector and the user request, as the cached response 410 in the cache 180. This may allow the text response to be retrieved from the cached response 410 at a later time.

At 622, the text response may be sent to the secondary language processor. For example, the response caching system 110 may send the text response from the machine learning system 120 to the secondary language processor 130 along with an instruction to summarize the text response. The text response may be sent through, for example, an API call to the secondary language processor 130. Flow may then proceed to 612, where the summarized response may be received by the response caching system 110, and 614, wherein the summarized response may be sent to the user that sent the user request.

Implementations of the presently disclosed subject matter may be implemented in and used with a variety of component and network architectures. FIG. 7 is an example computer 20 suitable for implementing implementations of the presently disclosed subject matter. As discussed in further detail herein, the computer 20 may be a single computer in a network of multiple computers. As shown in FIG. 7, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 8.

Many other devices or components (not shown) may be connected in a similar manner (e.g., document scanners, digital cameras and so on). Conversely, all of the components shown in FIG. 7 need not be present to practice the present disclosure. The components can be interconnected in different ways from that shown. The operation of a computer such as that shown in FIG. 7 is readily known in the art and is not discussed in detail in this application. Code to implement the present disclosure can be stored in computer-readable storage media such as one or more of the memory 27, fixed storage 23, removable media 25, or on a remote storage location.

FIG. 8 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving a vector comprising data and time values;
determining a point of interest in the vector, wherein the point of interest comprises data over a range of time values;
sending a request comprising the vector, the range of time values, and a request question to a machine learning system, wherein the request question requests that that machine learning system analyze the data of the vector based on the range of time values;
receiving, from the machine learning system, a text response;
storing, in a cache as a cached response, the text response, a vector identifier that identifies the vector, and at least one index indicating the range of time values;
receiving a user request from a user comprising an indication of data of interest and an indication of a time period of interest;
determining, based on the indications of the data of interest and the time period of interest, that the text response stored in the cache is responsive to the user request;
sending a request comprising the text response from the cache to a secondary language processor;
receiving, from the secondary language processor, a summarization of the text response; and
sending the summarization of the text response to the user.

2. The computer-implemented method of claim 1, wherein determining, based on the indications of the data of interest and the time period of interest, that the text response stored in the cache is responsive to the user request further comprises:
determining that the vector comprises the data of interest;
determining that the vector identifier of the cached response identifies the vector; and
determining that the at least one index indicating the range of time values of the cached response comprises the time period of interest.

3. The computer-implemented method of claim 1, further comprising:
receiving a second user request from a user comprising a second indication of data of interest and a second indication of time period of interest;
determining, based on the second indications of data of interest and a time period of interest, that no text response stored in the cache is responsive to the user request;
sending a second request to the machine learning system comprising a second vector and a second range of time values based on the second indications of the data of interest and the time period of interest, and a second request question based on the user request;
receiving, from the machine learning system, a second text response;
storing, in the cache, the second text response, a second vector identifier that identifies the second vector, and a second index comprising the second range of time values;
sending a second request to the secondary language processor comprising the second text response;
receiving, from the secondary language processor, a summarization of the second text response; and
sending the summarization of the second text response to the user.

4. The computer-implemented method of claim 3, determining, based on the second indications of data of interest and a time period of interest, that no text response stored in the cache is responsive to the user request further comprises:
determining the second vector that comprises the data of interest; and
determining that no cached response in the cache comprises both a vector identifier of the second vector and at least one index indicating a second range of time values that comprises the second time period of interest.

5. The computer-implemented method of claim 1, wherein the secondary language processor uses natural language processing to generate the summarization of the text response.

6. The computer-implemented method of claim 1, wherein determining a point of interest in the vector, wherein the point of interest comprises data over a range of time values further comprises identifying in the vector a maxima, a minima, a drop, or a rise.

7. The computer-implemented method of claim 1, wherein the vector comprises price data.

8. A computer-implemented system comprising:
one or more storage devices; and
a processor that receives a vector comprising data and time values,
determines a point of interest in the vector, wherein the point of interest comprises data over a range of time values,
sends a request comprising the vector, the range of time values, and a request question to a machine learning system, wherein the request question requests that that machine learning system analyze the data of the vector based on the range of time values,
receives, from the machine learning system, a text response,
stores, in a cache as a cached response, the text response, a vector identifier that identifies the vector, and at least one index indicating the range of time values,
receives a user request from a user comprising an indication of data of interest and an indication of a time period of interest,
determines, based on the indications of the data of interest and the time period of interest, that the text response stored in the cache is responsive to the user request,
sends a request comprising the text response from the cache to a secondary language processor,
receives, from the secondary language processor, a summarization of the text response, and
sends the summarization of the text response to the user.

9. The computer-implemented system of claim 8, wherein the processor determines, based on the indications of the data of interest and the time period of interest, that the text response stored in the cache is responsive to the user request by:
determining that the vector comprises the data of interest;
determining that the vector identifier of the cached response identifies the vector; and
determining that the at least one index indicating the range of time values of the cached response comprises the time period of interest.

10. The computer-implemented system of claim 9, wherein the processor further receives a second user request from a user comprising a second indication of data of interest and a second indication of time period of interest,
Determines, based on the second indications of data of interest and a time period of interest, that no text response stored in the cache is responsive to the user request,
sends a second request to the machine learning system comprising a second vector and a second range of time values based on the second indications of the data of interest and the time period of interest, and a second request question based on the user request,
receives, from the machine learning system, a second text response,
stores, in the cache, the second text response, a second vector identifier that identifies the second vector, and a second index comprising the second range of time values,
sends a second request to the secondary language processor comprising the second text response,
receives, from the secondary language processor, a summarization of the second text response, and
sends the summarization of the second text response to the user.

11. The computer-implemented system of claim 10, wherein the processor determines, based on the second indications of data of interest and a time period of interest, that no text response stored in the cache is responsive to the user request by:
determining the second vector that comprises the data of interest; and
determining that no cached response in the cache comprises both a vector identifier of the second vector and at least one index indicating a second range of time values that comprises the second time period of interest.

12. The computer-implemented system of claim 8, wherein the secondary language processor uses natural language processing to generate the summarization of the text response.

13. The computer-implemented system of claim 8, wherein the processor determines a point of interest in the vector, wherein the point of interest comprises data over a range of time values by identifying in the vector a maxima, a minima, a drop, or a rise.

14. The computer-implemented system of claim 8, wherein the vector comprises price data.

15. A system comprising: one or more computers and one or more non-transitory storage devices storing instructions which are operable, when executed by the one or more computers, to cause the one or more computers to perform operations comprising:
receiving a vector comprising data and time values;
determining a point of interest in the vector, wherein the point of interest comprises data over a range of time values;
sending a request comprising the vector, the range of time values, and a request question to a machine learning system, wherein the request question requests that that machine learning system analyze the data of the vector based on the range of time values;
receiving, from the machine learning system, a text response;
storing, in a cache as a cached response, the text response, a vector identifier that identifies the vector, and at least one index indicating the range of time values;
receiving a user request from a user comprising an indication of data of interest and an indication of a time period of interest;
determining, based on the indications of the data of interest and the time period of interest, that the text response stored in the cache is responsive to the user request;
sending a request comprising the text response from the cache to a secondary language processor;
receiving, from the secondary language processor, a summarization of the text response; and
sending the summarization of the text response to the user.

16. The system of claim 15, wherein the instructions which are operable, when executed by the one or more computers, to cause the one or more computers to perform operations comprising determining, based on the indications of the data of interest and the time period of interest, that the text response stored in the cache is responsive to the user request further cause the one or more computers to perform operations comprising:
determining that the vector comprises the data of interest;
determining that the vector identifier of the cached response identifies the vector; and
determining that the at least one index indicating the range of time values of the cached response comprises the time period of interest.

17. The system of claim 15, wherein the instructions are operable, when executed by the one or more computers, to further cause the one or more computers to perform operations comprising
receiving a second user request from a user comprising a second indication of data of interest and a second indication of time period of interest;
determining, based on the second indications of data of interest and a time period of interest, that no text response stored in the cache is responsive to the user request;
sending a second request to the machine learning system comprising a second vector and a second range of time values based on the second indications of the data of interest and the time period of interest, and a second request question based on the user request;
receiving, from the machine learning system, a second text response;
storing, in the cache, the second text response, a second vector identifier that identifies the second vector, and a second index comprising the second range of time values;
sending a second request to the secondary language processor comprising the second text response;
receiving, from the secondary language processor, a summarization of the second text response; and
sending the summarization of the second text response to the user.

18. The system of claim 17, wherein the instructions which are operable, when executed by the one or more computers, to cause the one or more computers to perform operations comprising determining, based on the second indications of data of interest and a time period of interest, that no text response stored in the cache is responsive to the user request further cause the one or more computers to perform operations comprising:
determining the second vector that comprises the data of interest; and
determining that no cached response in the cache comprises both a vector identifier of the second vector and at least one index indicating a second range of time values that comprises the second time period of interest.

19. The system of claim 15, wherein the secondary language processor uses natural language processing to generate the summarization of the text response.

20. The system of claim 19, wherein the instructions which are operable, when executed by the one or more computers, to cause the one or more computers to perform operations comprising determining a point of interest in the vector, wherein the point of interest comprises data over a range of time values further cause the one or more computers to perform operations comprising identifying in the vector a maxima, a minima, a drop, or a rise.
